(19) United States
(12) Patent Application Publication
(10) Pub. No.: US 2017/0317980 A1
(43) Pub. Date: Nov. 2, 2017

(54) INFORMATION PROCESSING DEVICE WITH NETWORK INTERFACE HAVING PROXY RESPONSE FUNCTION

(71) Applicant: CANON KABUSHIKI KAISHA, Tokyo (JP)

(72) Inventor: Yasuhiro Kozuka, Tokyo (JP)

(21) Appl. No.: 15/495,630

(22) Filed: Apr. 24, 2017

(30) Foreign Application Priority Data
Apr. 28, 2016 (JP) 2016-091613

(51) Int. Cl. H04L 29/06; G06F 13/10; G06F 1/32; G06F 13/24; G06F 13/40; G06F 13/42

(52) U.S. Cl. CPC H04L 63/0281; G06F 13/4068; G06F 13/4282; G06F 1/3234; G06F 13/24; G06F 13/102; G06F 2213/0026

(57) ABSTRACT

An information processing device that can communicate with an external device includes a controller for controlling the information processing device, and a network interface for communicating data with the external device via a network. The network interface performs proxy response for responding to specific data received from the external device via the network to the external device without the controller. The network interface includes a storage unit for storing system status information indicating a power state of the information processing device and determines whether or not to perform the proxy response on the basis of the system status information stored in the storage unit.

### BACKGROUND OF THE INVENTION

### Field of the Invention

The present invention relates to an information processing device having a network interface with a proxy response function.

### Description of the Related Art

An information processing device such as personal computer and MFP (Multi Function Peripheral) has S0 state, S3 state, S5 state, and the like defined by a standard regarding power control called ACPI. ACPI is an abbreviation of Advanced Configuration and Power Interface. A state with a prefix of “S” indicates a power state of a system (controller unit) of an information processing device. The S0 state is a standby state, the S3 state is a sleep state that consumes less power than the standby state, and the S5 state is a power off state. In the S0 state, power is being supplied to a system of an information processing device. The S3 state is also referred to as suspend state, and information indicating a state of a CPU of the system and the like are saved in a memory and power supply to the CPU is stopped in the S3 state. The S5 state is a state in which power supply to each unit of the information processing device is stopped.

Generally, in a known peripheral device of a CPU, it becomes D0 state when the power state of the system is the S0 state and it becomes D3 state that consumes less power than the D0 state when the power state of the system is the S3 state. Specifically, a network interface (hereinafter referred to as “network I/F”) connected to the CPU via a PCI Express bus becomes the D0 state when the information processing device is the S0 state and becomes the D3 state when the information processing device is the S3 state. In the D3 state, less power consumption of the peripheral device is sought by turning off the power supplied to the peripheral device and stopping supply of a clock signal.

The network I/F that has become the D3 state can respond to a packet received from an external device via a network in place of the CPU to which power supply is stopped (see Japanese Patent Laid-Open No. 2010-283696). This technique is referred to as proxy response. The network I/F performs proxy response when a value of a register called PMCSR (Power Management Control/Status Register) in the network I/F indicates the D3 state.

### SUMMARY OF THE INVENTION

In a recent information processing device, it is possible to make a state of a peripheral device of a CPU the D3 state while the power state of the system is the S0 state in order to obtain much less power consumption in the standby state. The technique to control the peripheral device of the CPU to be the D3 state while the power state of the system is the S0 state is referred to as Runtime D3.

When the technique of Runtime D3 described above is used, the network I/F sometimes becomes D3 state while the power state of the system is the S0 state. Since the network I/F performs proxy response when the value of PMCSR indicates the D3 state, the network I/F performs proxy response in some cases when the power state of the system is the S0 state.

The proxy response is for the network I/F to make a response to a packet transmitted from an external device in place of a CPU when power supply to the CPU is stopped. Therefore, it is better that the CPU responds to a packet received from an external device even if the network I/F is the D3 state in the S0 state in which power is supplied to the CPU.

Then, embodiments of the invention provide an information processing device in which a network interface can perform proxy response on the basis of a power state of a system.

Embodiments of the present invention include an information processing device that can communicate with an external device including a controller for controlling the information processing device and a network interface for communicating data with the external device via a network. The network interface performs proxy response for transmitting a response to specific data received from the external device via the network to the external device without the controller. The network interface includes a storage unit for storing system status information indicating a power state of the information processing device and determines whether or not to perform the proxy response on the basis of the system status information stored in the storage unit.

Further features of the present invention will become apparent from the following description of exemplary embodiments (with reference to the attached drawings).

### BRIEF DESCRIPTION OF THE DRAWINGS

FIG. 1 is a block diagram illustrating an entire configuration of an MFP.

FIG. 2 is a block diagram illustrating a power supply unit in detail.

FIG. 3 is a block diagram illustrating a controller unit in detail.

FIG. 4 is a block diagram illustrating a CPU and a PCI device connected to the CPU in detail.

FIG. 5 is a block diagram illustrating a software.

FIG. 6 shows power state of the MFP.

FIG. 7A shows active state of wait response mode, and FIG. 7B shows low power state of the wait response mode.

FIG. 8A is a flow chart showing a process of a power supply control application, and FIG. 8B is a flow chart showing a process of a device driver.

FIG. 9 is a flow chart for validating/invalidating a proxy response function.

FIG. 10 is a flow chart showing an operation of a LAN controller.

FIG. 11 is a flow chart showing an interruption operation of the LAN controller.

FIG. 12 is a block diagram illustrating a CPU and a PCI device connected to the CPU according to the second embodiment in detail.

FIG. 13 is a block diagram illustrating a CPU and a PCI device connected to the CPU according to the third embodiment in detail.

### DESCRIPTION OF THE EMBODIMENTS

### First Embodiment

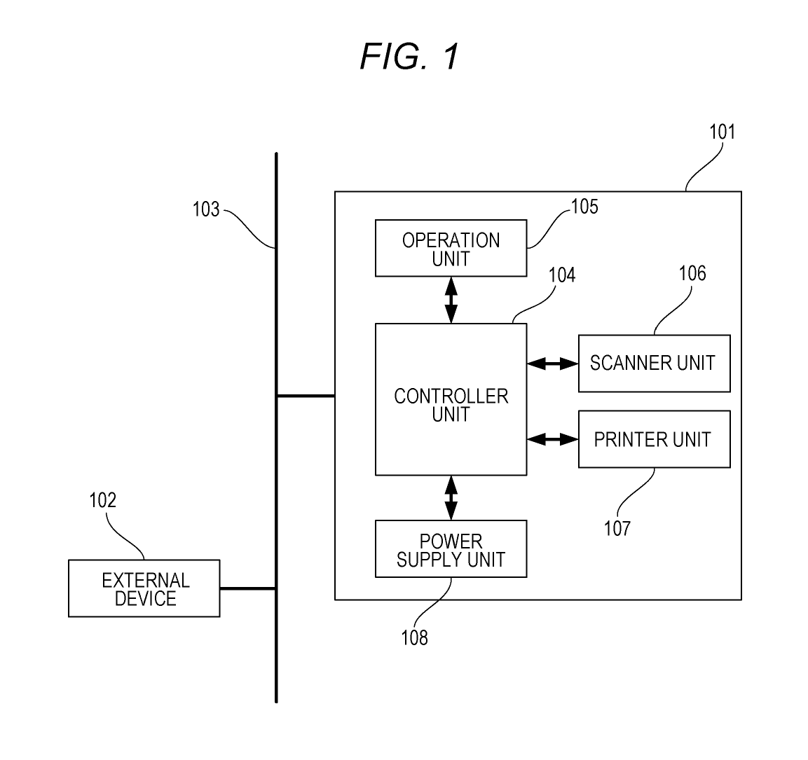

FIG. 1 is a block diagram illustrating an overview configuration of an MFP 101.

The MFP 101 is connected to an external device 102 so as to communicate data therewith via a network 103. The network 103 is, for example, Ethernet (registered trademark). The external device 102 is a personal computer and connected to the MFP 101 so as to communicate therewith. The MFP 101 can perform several functions such as copy function, print function, scan function, and FAX function.

The MFP 101 includes a controller unit 104, an operation unit 105, a scanner unit 106, a printer unit 107, and a power supply unit 108. The operation unit 105, the scanner unit 106, and the printer unit 107 are function units for performing each function of the MFP 101, and the controller unit 104 is a control unit for controlling the function unit.

The operation unit 105 includes hard keys such as ten key for a user to input the number of print-outs and the like, start key for the user to instruct start of printing, and power saving key for the user to set the MFP 101 to sleep mode. In addition, the operation unit 105 includes a display unit for displaying various information. This display unit is a display unit of touch panel type.

The scanner unit 106 scans an image on a document, converts the scanned image to digital data, and outputs the digital data to the controller unit 104.

The printer unit 107 forms an image on a sheet on the basis of the image data processed by the controller unit 104.

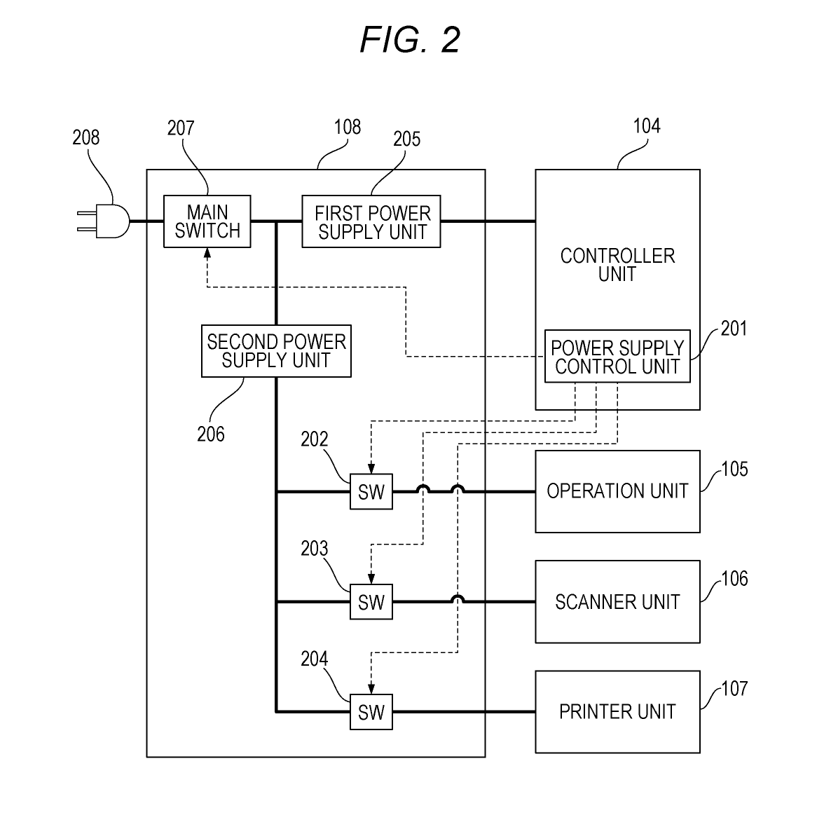

The power supply unit 108 converts alternating voltage input via a power supply plug 208 (see FIG. 2) to direct voltage. The power supply unit 108 supplies the converted direct voltage to each unit of the MFP 101.

FIG. 2 is a block diagram illustrating the power supply unit 108 in detail.

Alternating voltage is input to the power supply unit 108 via the power supply plug 208. The alternating voltage input via the power supply plug 208 is supplied to each of a first power supply unit 205 and a second power supply unit 206. The first power supply unit 205 generates direct voltage of about 5.0 V from the alternating voltage, for example. In addition, the second power supply unit 206 generates direct voltage of about 24.0 V from the alternating voltage, for example.

The direct voltage generated by the first power supply unit 205 is supplied to the controller unit 104. In addition, the direct voltage generated by the second power supply unit 206 is supplied to the operation unit 105, the scanner unit 106, and the printer unit 107. Note that, power generated by the first power supply unit 205 may be supplied to a part of the operation unit 105 that detects key input.

A main switch 207 is provided between the power supply plug 208 and the first power supply unit 205 or the second power supply unit 206. The main switch 207 is a rocker switch, and becomes an off state or an on state by an operation of the user. The switch 207 may be a tact switch.

In addition, a relay switch 202 is provided between the second power supply unit 206 and the operation unit 105. Moreover, a relay switch 203 is provided between the second power supply unit 206 and the scanner unit 106. Furthermore, a relay switch 204 is provided between the second power supply unit 206 and the printer unit 107.

A power supply control unit 201 of the controller unit 104 can switch the main switch 207 from an on state to an off state by driving a solenoid (not illustrated). In addition, the power supply control unit 201 can switch on or off each of the relay switches 202 to 204.

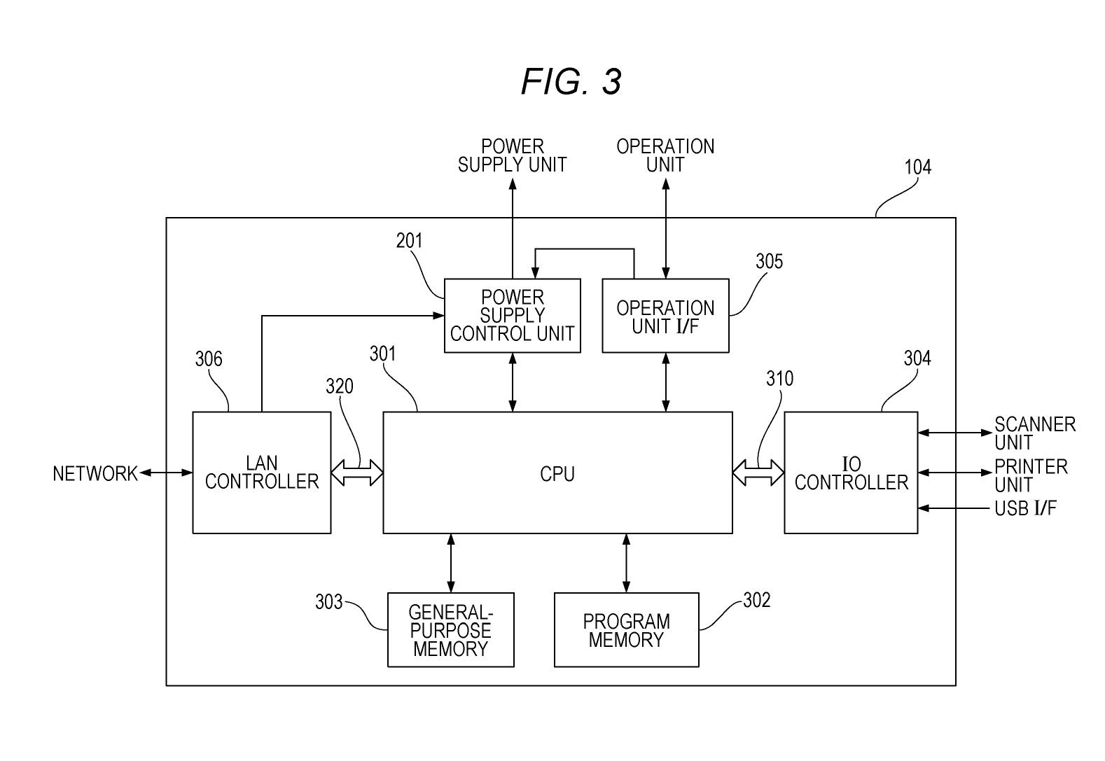

FIG. 3 is a block diagram illustrating the controller unit 104 in detail.

The controller unit 104 includes a CPU 301, a program memory 302, a general-purpose memory 303, an IO controller 304, an operation unit interface 305, a LAN controller (network I/F) 306, and the power supply control unit 201.

The CPU 301 is connected to the IO controller 304 via a PCIe bus 310 so as to communicate therewith. In addition, the CPU 301 is connected to the LAN controller 306 via a PCIe bus 320 so as to communicate therewith. The PCIe buses 310 and 320 are buses compliant with PCI Express standard, and the IO controller 304 and the LAN controller 306 are PCI devices compliant with PCI Express standard.

The CPU 301 executes a program stored in the program memory 302 such as flash memory. The program memory 302 stores a program and control data that control the MFP 101. The CPU 301 develops the program loaded from the program memory 302 to the general-purpose memory 303. The general-purpose memory 303 is used as a work memory of the CPU 301.

The IO controller 304 is a processor for carrying out image processing and connected to the scanner unit 106 and the printer unit 107 so as to communicate therewith. The IO controller 304 carries out image processing on the image data corresponding to the image on the document read by the scanner unit 106. In addition, the IO controller 304 carries out image processing on the image data corresponding to the image to be printed by the printer unit 107.

The operation unit interface 305 is an interface for connecting the operation unit 105 and the CPU 301. Information about key operation of the operation unit 105 and operation of the touch panel is transmitted to the CPU 301. In addition, the operation unit interface 305 transmits screen data to be displayed on a display unit of the operation unit 105 to the operation unit 105.

The LAN controller 306 is a network interface for communicating with the external device 102 connected to the network 103.

The power supply control unit 201 is a logic circuit for controlling power supply to each unit of the MFP 101. The power supply control unit 201 detects a signal input from the operation unit 105 via the operation unit interface 305, a signal input from the network 103 via the LAN controller 306, and the like to restore the MFP 101 from sleep mode described later. Note that, the interrupt signal input from the power supply control unit 201 includes a signal from a sensor for detecting recording paper to be printed by the printer unit 107, a signal from a sensor for detecting a document to be read by the scanner unit 106, and a signal from a human body detection sensor.

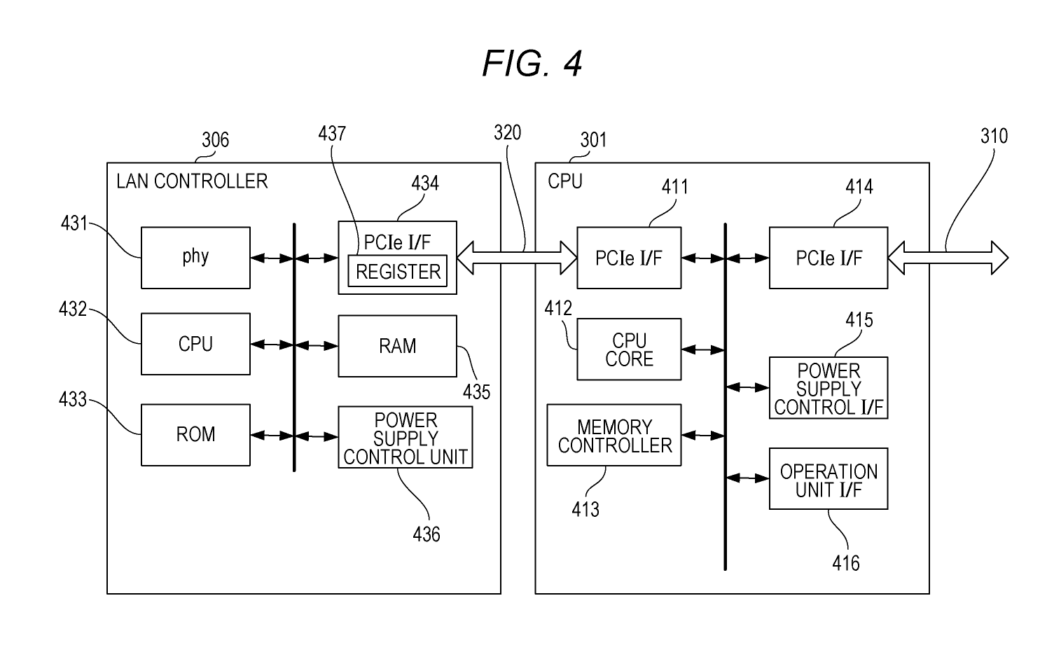

FIG. 4 is a block diagram illustrating the CPU and the LAN controller in detail.

The CPU 301 includes a PCIe I/F 411, a CPU core 412, a memory controller 413, a PCIe I/F 414, a power supply control I/F 415, and an operation unit I/F 416. The PCIe I/F 411 is an interface for communicating with the LAN controller 307 via the PCIe bus 320. The CPU core 412 carries out various processing. The CPU core may be a single core or a multi core. The memory controller 413 controls writing of date to the general-purpose memory 303 and reading of data from the general-purpose memory 303. The PCIe I/F 414 is an interface for communicating with the IO controller 304 via the PCIe bus 310. The power supply control I/F 415 is an interface for communicating with the power supply control unit 201. The operation unit I/F 416 is an interface for communicating with the operation unit 105. Each of the PCIe I/Fs 411 and 414 receives and transmits data in accordance with PCI Express standard.

The LAN controller 306 includes a phy 431, a CPU 432, a ROM 433, a PCIe I/F 434, a RAM 435, and a power supply control unit 436. The LAN controller 306 as a PCI device can shift between D0 state (normal power state) and D3 state (power saving state). The D0 state is an active state in which power is supplied to all blocks in the LAN controller 306. In addition, the D3 state is a state in which power supply to some blocks in the LAN controller 306 is stopped or clock supply is stopped. Note that, in the D3 state, clock frequency supplied to some blocks in the LAN controller 306 may be lowered. The LAN controller 306 has a proxy response function for responding to the data received from the external device 102 in place of the CPU 301. Specifically, the LAN controller 306 generates a response packet of an ARP packet (including MAC address of the MFP 101) to transmit to the external device 102 when it receives the ARP packet from the external device 102. ARP is an abbreviation of Address Resolution Protocol. In addition, the LAN controller 306 refers to MIB and generates a response packet to an SNMP packet (including status information of the MFP 101) to transmit to the external device 102 when it receives the SNMP packet from the external device 102. SNMP is an abbreviation of Simple Network Management Protocol. In addition, MIB is an abbreviation of Management Information Base.

The phy 431 receives data from the external device 102 and transmits data to the external device 102.

The CPU 432 controls operation of the LAN controller 306.

The ROM 433 stores a pattern list to be compared with the packet received by the network I/F. The pattern list includes a pattern for which proxy response is to be performed and a pattern for which uprising is to be performed. The CPU 432 performs proxy response if the packet pattern of the received data corresponds to a pattern for which proxy response is to be performed (if specific data is received). In addition, the CPU 432 outputs an interrupt signal to the power supply control unit if the packet pattern of the received data corresponds to a pattern for which uprising is to be performed. Accordingly, the power supply control unit restores the system from the S3 state to the S0 state.

The PCIe I/F 434 communicates with the PCIe I/F 411 of the CPU 301 in accordance with PCIe standard. The PCIe I/F 434 includes a register 437 that stores device status information indicating power state of the LAN controller 306. Specifically, the device status information indicates D0 state or D3 state. The register 437 is a PMCSR (Power Management Control/Status Register).

The value of the register 437 of the PCIe I/F 434 is overwritten by the CPU 301 via the PCIe bus 320.

The RAM (storage unit) 435 is used as a work area of the CPU 432. The RAM 435 according to the present embodiment stores system status information indicating power state of the system. The system status information is information indicating power state of the controller unit 104 of the MFP 101. Specifically, the system status information indicates S0 state, S3 state, or S5 state. Note that, the system status information may indicate state other than S0 state, S3 state, and S5 state (for example, S4 state).

The power supply control unit 436 controls power inside the LAN controller 306 on the basis of the device status information stored in the register 437. Specifically, the power supply control unit 436 supplies power to each part of the LAN controller 306 when the device status information indicates D0 state. In addition, the power supply control unit 436 stops power supply to the PCIe I/F 434 when the device status information indicates D3 state. Note that, the power supply control unit 436 may stop clock supply to the PCIe I/F 434 or reduce clock frequency when the device status information indicates D3 state.

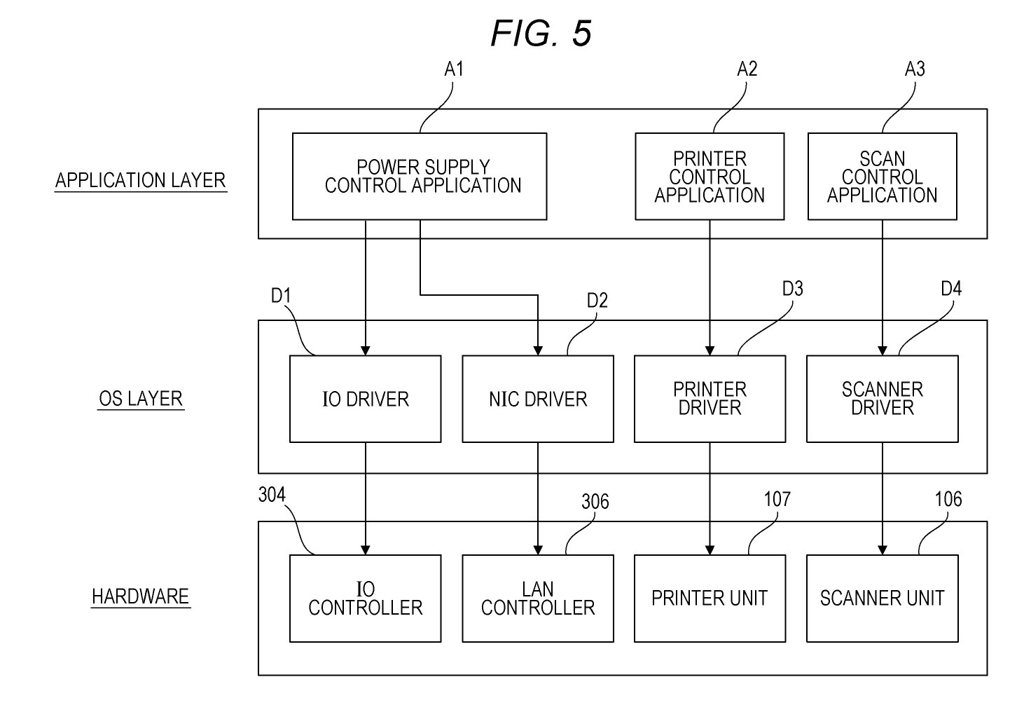

FIG. 5 is a software block diagram illustrating a configuration of software of the MFP 101.

A power supply control application A1, which is software for controlling power of the MFP 101, operates at an application layer. The power supply control application A1 periodically inquires about status of execution of a job and the like to a print control application A2, a scan control application A3, and the like that operate at an application layer. Then, the power supply control application A1 controls power mode of the MFP 101 on the basis of the status of execution of the job and the like. The CPU 301 that executes the power supply control application A1 accesses the power supply control unit 201 to change the power mode of the MFP 101. Then, in the present embodiment, the power supply control application A1 notifies device drivers D1 and D2 of the power mode of the MFP 101.

The IO driver D1 that controls operation of the IO controller 304 is a device driver and operates at an OS layer. In addition, the NIC driver D2 that controls operation of the LAN controller 306 is also a device driver and operates at an OS layer. Moreover, a printer driver D3 that controls operation of the printer unit 107 and a scanner driver D4 that controls operation of the scanner unit 106 also operate at an OS layer.

Note that, although description is omitted here, software executed at an application layer or an OS layer is not limited to the software described above. Various software operate such as memory controller for controlling the general-purpose memory 303 and a graphic driver for controlling display on the display unit of the operation unit 105.

Here, a method in which the device driver turns the PCI device into D0 state and D3 state will be described.

First, a method in which the device driver shifts the PCI device from D0 state to D3 state will be described.

1. The device driver detects that the PCI device is idle state.

2. The device driver activates an idle timer.

3. The device driver stops the idle timer when the PCI device becomes active state.

4. The idle timer notifies the device driver when it recognizes a predetermined time.

5. The device driver writes in the PMCSR (Power Management Control/Status Register) in the PCI device that it is D3 state.

6. The power control unit in the PCI device refers to the PMCSR to stop power supply to a unit in the PCI device, stop clock supply, or reduce clock frequency.

Next, a method in which the device driver shifts the PCI device from D3 state to D0 state will be described.

1. The device driver detects that the PCI device is active state.

2. The device driver writes in the PMCSR in the PCI device that it is D0 state.

3. The power control unit in the PCI device refers to the PMCSR to restart power supply to a unit in the PCI device, restart clock supply, or restore clock frequency.

The PMCSR is in the PCIe I/F in the PCI device, and the PCIe I/F of the CPU 301 overwrites a value of the PMCSR. The CPU 301 is only required to overwrite a value of the register (PMCSR) of the PCI device in order to change the state of the PCI device. When the value of the register is overwritten, the PCI device itself carries out power supply and clock control in the PCI device.

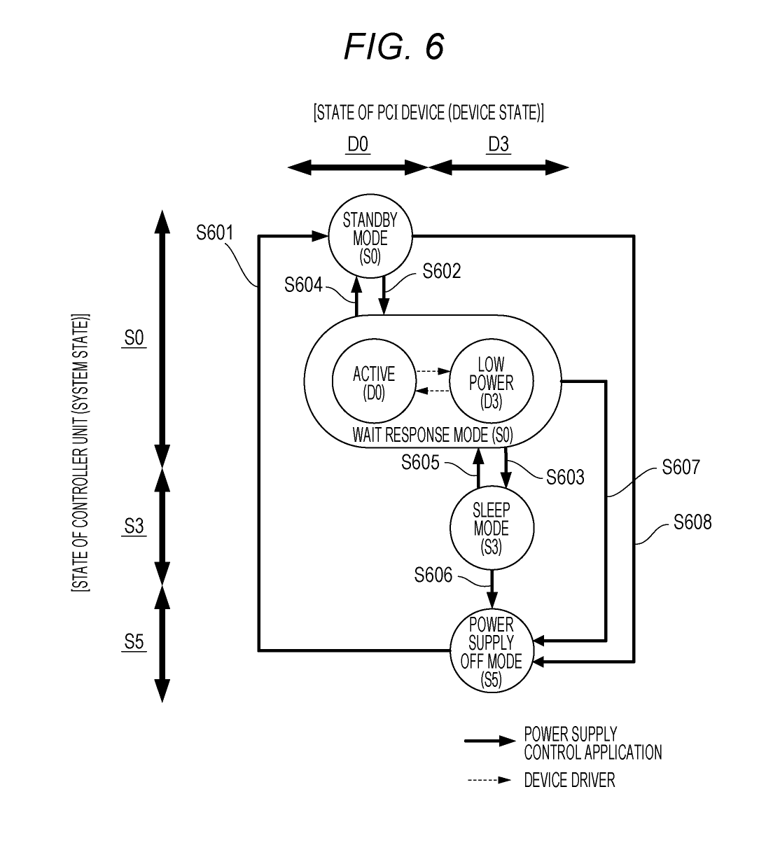

FIG. 6 illustrates power state of the MFP 101.

The MFP 101 according to the present embodiment can shift to S0 state (standby state), S3 state (sleep state), and S5 state (power off state) defined by ACPI. In the present embodiment, a state in which power is supplied to the CPU 301, which is a main CPU of the MFP 101, is S0 state. In addition, a state in which power supply to the CPU 301 is stopped but power is supplied to the general-purpose memory 303, which is a main memory, is S3 state. Moreover, a state in which power supply to each part of the MFP 101 such as the CPU 301 and the general-purpose memory 303 is stopped is S5 state.

### <S0 State>

The MFP 101 has S0 state in which the controller unit 104 becomes standby state. The S0 state includes standby mode in which power is supplied to a function unit such as the printer unit 107 and the scanner unit 106 and wait response mode in which power supply to a function unit is stopped. For example, when executing printing process, it is necessary to supply power to the CPU 301 and the printer unit 107, but it is not necessary to supply power to the scanner unit 106. On the other hand, when executing scanning process, it is necessary to supply power to the CPU 301 and the scanner unit 106, but it is not necessary to supply power to the printer unit 107. Moreover, when responding to an inquiry from the external device 102, it is necessary to supply power to the CPU 301, but it is not necessary to supply power to the printer unit 107 and the scanner unit 106. Since power is supplied to one of function units when executing printing process and when executing scanning process, the MFP 101 becomes standby mode. On the other hand, since power is supplied to a function unit when responding to an inquiry, it becomes wait response mode.

When the MFP 101 is standby mode, power is supplied to each unit of the MFP 101 (the controller unit 104, the operation unit 105, the scanner unit 106, and the printer unit 107). In addition, when the MFP 101 is wait response mode, power is supplied to the controller unit 104 of the MFP 101, but power is not supplied to the scanner unit 106 and the printer unit 107. The PCI device becomes D0 state and does not shift to D3 state in standby mode, but the PCI device shifts between D0 state (active) and D3 state (low power) in wait response mode.

The reason why power supply to the CPU 301 is not stopped in wait response mode (S0) is to obtain better communication responsiveness with the external device 102 via the network. Recently, the number of the external device 102 connected to a network such as PC, server, and mobile terminal has increased and the MFP 101 needs to quickly communicate with the external device 102. This is because it needs to communicate various items such as remaining amount of toner, remaining amount of sheets, sheet jam, information on occurrence of error, confirmation of version of software program, version-up, and download of new program.

Generally, the PCI device becomes D0 state in the S0 state and the PCI device becomes D3 state in the S3 state. Recently, a technique called Runtime D3 is realized in which the PCI device is shifted to D3 state even in the S0 state. Then, Runtime D3 is realized also in the MFP 101 according to the present embodiment. Specifically, the MFP 101 according to the present embodiment executes Runtime D3 in wait response mode of the S0 state. Note that, Runtime D3 is not executed in standby mode.

### <S3 State>

In the S0 state, power is supplied to the CPU 301 of the controller unit 104. In order to reduce power consumption, the MFP 101 shifts to S3 state. S3 state is also referred to as suspend state. In the S3 state, power supply to the CPU 301 is stopped to obtain low power consumption of the MFP 101. In the S3 state, states of the CPU 301 and the like are saved in the general-purpose memory 303, and the general-purpose memory 303 becomes self-refresh mode. When restoring it from the S3 state, it is possible to restore it more quickly than a case in which activation is performed from boot ROM by resuming with the use of the information saved in the general-purpose memory 303.

In the S3 state, the PCI device becomes D3 state.

### <S5 State>

When the main switch 207 becomes off state, it shifts to the S5 state in which power supply to the MFP 101 is stopped. In the S5 state, power supply to each part of the MFP 101 is stopped and power supply to the CPU 301 and the general-purpose memory 303 is also stopped.

Next, shifts of power state will be described in detail.

### <S601: S5 State->S0 State>

The power supply off mode (S5) is a state in which the main switch 207, which is a power supply switch of the MFP 101, is off and power supply to each unit is shut. When the main switch 207 becomes on state, it shifts to standby mode (S0). The standby mode (S5) is a state in which power is supplied to all units of the MFP 101 and various jobs such as copying and printing are executed, or jobs are ready to be executed.

### <S602: S0 State (Standby Mode)->S0 State (Wait Response Mode)>

The wait response mode (S0) is a state in which the relay switches 202 to 204 of the power supply unit 108 are off and power supply to the scanner unit 106, the printer unit 107, and the operation unit 105 is stopped. On the other hand, the first power supply unit 205 supplies power to parts of the controller unit 104 and the operation unit 105. Both the standby mode and the wait response mode are S0 state.

Table 1 shows conditions of shift from standby mode (S0) to wait response mode (S0).

TABLE 1
Conditions of Shift from Standby Mode (S0) to Wait
Response Mode (S0)

| Shift Condition | Description |
|---|---|
| Time Lapse | When a predetermined time has |
| | passed. |
| Pressing of Switch of | When a power-saving switch of the |
| Operation Unit | operation unit 105 is pressed. |
| Time Setting | When the set time has come. |

When any conditions of time lapse, pressing of switch of the operation unit, and time setting is satisfied, the MFP 101 shifts from standby mode (S0) to wait response mode (S0).

Time lapse of the shift condition of Table 1 means that elapsed time after operation of the operation unit 105 is completed or elapsed time after a job is completed has exceeded a predetermined time. The user can set time between several minutes and several hours as the predetermined time. Pressing of switch of the operation unit means that the user presses power saving key (not illustrated) of the operation unit 105. Time setting means that the time that has set by the user in advance has come.

### <S603: S0 State->S3 State>

The sleep mode (S3) is a state in which power supply to the CPU 301 and the IO controller 304 is stopped from the power state of the wait response mode (S0). The sleep mode (S3) is low power state in which power is only supplied to parts necessary to cause the MFP 101 to be restored from the sleep mode (S3) to the standby mode (S0) or the wait response mode (S0). In the S3 state, power supply to the CPU 301 is stopped, which is a difference from the S0 state. Specifically, in the sleep mode (S3), power is supplied only to the general-purpose memory 303, the operation unit interface 305, the power supply control unit 201, and the LAN controller 306 of FIG. 3. Moreover, the general-purpose memory 303 shifts to refresh mode. The LAN controller 306 responds to an inquiry from the external device 102 with power supply to the CPU 301 stopped as long as the LAN controller 306 can respond. This is called proxy response. Note that, in the sleep mode (S3), the LAN controller 306 and the IO controller 304, which are PCI devices, are D3 state.

Table 2 shows conditions of shift from wait response mode (S0) to sleep mode (S3).

TABLE 2
Conditions of Shift from Wait Response Mode (S0) to
Sleep Mode (S3)

| Shift Condition | Description |
|---|---|
| Time Lapse | When a predetermined time has passed. |
| Completion of | When a process in response to an inquiry |
| Job processing | is completed after an inquiry is received |
| other than | from the external device 102 and the MFP |
| Printing | 101 shifts from the sleep mode (S3) to the |
| | wait response mode (S0). |

When one of conditions of time lapse and completion of job processings other than printing is satisfied, the MFP 101 shifts from wait response mode (S0) to sleep mode (S3).

Time lapse of the shift condition of Table 2 means that the elapsed time after completion of execution of a job has exceeded a predetermined time. The user can set time between several minutes and several hours as the predetermined time. Completion of job processing other than printing means that a response to an inquiry from the external device 102 via the network has been completed.

<S604: S0 state (wait response mode)->S0 state (standby mode)>

Table 3 shows conditions of restoration from wait response mode (S0) to standby mode (S0).

TABLE 3
Conditions of Restoration from Wait Response Mode
(S0) to Standby Mode (S3)

| Restoration | |
|---|---|
| Condition | Description |
| Pressing of Switch | When a power-saving switch of the |
| of Operation Unit | operation unit 105 is pressed. |
| Job Receipt | When a print job or the like is |
| | received from a network. |
| Time Setting | When the set time has come. |
| Detection of USB | When a USB device is detected in a USB |
| Device | interface or when a USB device detects |
| | a factor of restoration. |

When any conditions of pressing of switch of operation unit, job receipt, time setting, and detection of USB device is satisfied, the MFP 101 shifts from wait response mode (S0) to standby mode (S0).

Pressing of switch of operation unit in the restoration conditions of Table 3 means that the user presses a power saving key of the operation unit 105 (not illustrated). When a power saving key is pressed by the user, a signal from the power saving key of the operation unit 105 is detected by the CPU 301 via the operation unit interface 305. In addition, job receipt means that a print job is received from the external device 102 via the network 103. Time setting means that the current time measured by a clock unit comes to the time set in advance. Detection of USB device means that connection of a USB device to a USB I/F 428 is detected or that an already-connected USB device detects a factor of restoration. Factors of restoration to be detected by a USB device includes detection of a card by an authentication card reader as a USB device and detection of a human by a camera device or a human detection sensor as a USB device. The restoration condition is not limited to the conditions described above and may be detection of a document placed on a document table by a document detection sensor of the scanner unit 106 and detection of a sheet placed on a manual sheet tray of the printer unit 107.

<S605: S3 state->S0 State>

Table 4 shows conditions of restoration from sleep mode (S3) to wait response mode (S0) or standby mode (S0).

TABLE 4
Conditions of Restoration from Sleep Mode (S3) to
Wait Response Mode (S0) or Standby Mode (S0)

| Restoration Condition | Description |
|---|---|
| Pressing of Switch of | When a power-saving switch of the |
| Operation Unit | operation unit 105 is pressed. |
| Print Job Receipt | When a print job is received from a |
| | network. |
| Receipt of Job Other | When a job not to print or an |
| than Printing | inquiry is received from a network. |
| Time Setting | When the set time has come. |

When any condition of pressing of switch of operation unit, receipt of print job, receipt of job other than printing, and time setting is satisfied, the MFP 101 restores from sleep mode (S3) to wait response mode (S0).

Pressing of switch of operation unit in the restoration conditions of Table 4 means that the user presses a power saving key of the operation unit 105 (not illustrated). When a power saving key is pressed by the user, a signal from the power saving key of the operation unit 105 is detected by the CPU 301 via the operation unit interface 305. Print job receipt means that a print job is received from the external device 102 via the network 103. Time setting means that the current time measured by a clock unit comes to the time set in advance. Receipt of job other than printing means that job for inquiring about information of the MFP 101 (hereinafter referred to as “device information”) (inquiring job) for which the LAN controller 306 cannot perform proxy response is received from the external device 102 via the network.

When the restoration condition described above is detected in the sleep mode (S3), an interrupt signal is input to the power supply control unit 201. When an interrupt signal is input, the power supply control unit 201 controls power so that power is supplied to the CPU 301 and the program memory 302. The CPU 301 to which power is supplied carries out resuming process with the information saved in the general-purpose memory 303. In addition, the power supply control unit 201 supplies power to a function unit on the basis of a type of the interrupt signal. Specifically, when an interrupt signal regarding a print job is input, the power supply control unit 201 supplies power to the printer unit 107 as well as to the CPU 301 and the general-purpose memory 303. On the other hand, when an inquiry is received, when a power saving key is pressed, and when the set time has come, the power supply control unit 201 supplies power to the CPU 301 and the general-purpose memory 303, but does not supply power to the printer unit 107.

<S606: S3 state->S5 State>

Table 5 shows conditions of shift from sleep mode (S3) to power supply off mode (S5).

TABLE 5
Conditions of Shift from Sleep Mode (S3) to Power
Supply Off Mode (S5)

| Restoration | |
|---|---|
| Condition | Description |
| Pressing of Main | When a main switch is pressed. |
| Switch | |
| Time Lapse | When a predetermined time has passed in |
| | the sleep mode. |

When one of conditions of pressing of main switch and time lapse is satisfied, the MFP 101 restores from sleep mode (S3) to power supply off mode (S5).

Pressing of main switch of the restoration conditions of Table 5 means that the user moves the main switch 207 to off state. In addition, time lapse means that predetermined time has passed in the sleep mode (S3). The user can set time between several minutes and several hours as the predetermined time.

### <S607, S608: S0 State->S5 State>

If the user moves the main switch 207 to off state when the MFP 101 is S0 state, the MFP 101 shifts to power supply off mode (S5). Note that, power supply off mode (S5) may be suspend state (S3 of ACPI standard) or hibernation state (S4 of ACPI standard).

Next, power control of the PCI device (LAN controller 306) will be described.

In the present embodiment, the PCI device corresponds to Runtime D3, and the controller unit 104 can shift the PCI device between D0 state and D3 state even in S0 state. In the present embodiment, the PCI device shifts between D0 state and D3 state only when the MFP 101 is wait response mode (S0).

Table 6 shows correspondence of power mode of the MFP 101 and power state of the PCI device. As shown in Table 6, the MFP 101 controls power state of the PCI device on the basis of power mode of the MFP 101.

TABLE 6
Power State of PCI Device (LAN Controller 306)

Power State of Device

| | | D0 | D3 |
|---|---|---|---|
| Power Mode | Standby Mode | ◯ | X |
| of MFP 101 | Wait Response | When making a | ◯ |
| | Mode | response | |
| | Sleep Mode | X | ◯ |
| | Power Supply Off | Off | Off |
| | Mode | | |

As shown in Table 6, the PCI device becomes D0 state when the power mode of the MFP 101 is standby mode (S0) and the PCI device becomes D3 state when the power mode of the MFP 101 is sleep mode (S3). In addition, power supply to the PCI device is stopped when the power mode of the MFP 101 is power supply off mode (S5).

Then, in the present embodiment, the PCI device shifts between D0 state and D3 state when the MFP 101 is wait response mode (S0). The D0 state of the PCI device in the wait response mode (S0) and the D0 state of the PCI device in the standby mode (S0) are the same state. However, in the wait response mode (S0), power supply to the scanner unit 106 and the printer unit 107 is stopped, which is a difference from the standby mode (S0).

Table 7 shows conditions of shift of the PCI device from D0 state to D3 state in wait response mode (S0).

TABLE 7
Conditions of Shift of PCI Device (Wait Response
Mode)

| Shift | |
|---|---|
| Condition | Description |
| Time Lapse | When the power mode of the MFP 101 is wait |
| | response mode and a predetermined time has |
| | passed with the PCI device being idle state. |

The condition of shift of the PCI device from D0 state to D3 state is time lapse. That is satisfied when the power mode of the MFP 101 is wait response mode (S0) and a predetermined time has passed with the PCI device being idle state. The frequency of shift of the PCI device between D0 state and D3 state is higher than the frequency of change of the power mode of the MFP 101. The predetermined time can be set between several seconds and several milliseconds.

Next, Table 8 shows conditions of restoration of the PCI device from D3 state to D0 state in wait response mode (S0).

TABLE 8
Conditions of Restoration of PCI Device (Wait
Response Mode)

| Restoration Condition | Description |
|---|---|
| Detection of Factor of | Detection of Factor of |
| Restoration by CPU | Restoration by Device |
| When the CPU detects a | When the device detects a |
| factor of restoration. | factor of restoration. |

The conditions of restoration of the PCI device from D3 state to D0 state are detection of a factor of restoration by the CPU 301 and detection of a factor of restoration by the PCI device. That is, the PCI device can be restored to D0 state from both the CPU 301 and the PCI device in D3 state.

Detection of factor of restoration by CPU shown Table 8 means detection of a factor of restoration by the CPU 301. For example, it means that the power state of the MFP 101 is changed from wait response mode to standby mode. Specifically, when the power supply control application A1 changes the power state of the MFP 101 from wait response mode to standby mode, the device driver executed by the CPU 301 shifts the PCI device from D3 state to D0 state. In addition, when the setting of the PCI device is changed or when the device information of the PCI device is acquired, the device driver accesses the PCI device. At that time, the device driver shifts the PCI device from D3 state to D0 state. For example, information is transmitted from the LAN controller 306 to the external device 102 via the network 103 at a predetermined time in some cases. When the current time measured by the clock unit 414 becomes a predetermined time, an interrupt signal is input to the CPU 301. The CPU 301 overwrites a value of the register of the PCI device when an interrupt signal is input. Accordingly, the PCI device is restored from D3 state to D0 state. As a result, the LAN controller 306 can transmit information to the external device 102.

In addition, detection of factor of restoration by device shown in Table 8 means detection of a factor of restoration by the PCI device. For example, it means that data is received by the LAN controller 306 from the external device 102 via the network 103 and that the USB I/F 428 detects the USB device. When the PCI device detects a factor of restoration, the PCI device outputs an interrupt signal to the CPU 301 at out-band (outside PCIe bus). The CPU 301 overwrites a value of the register of the PCI device when an interrupt signal is input. Accordingly, the PCI device is restored from D3 state to D0 state.

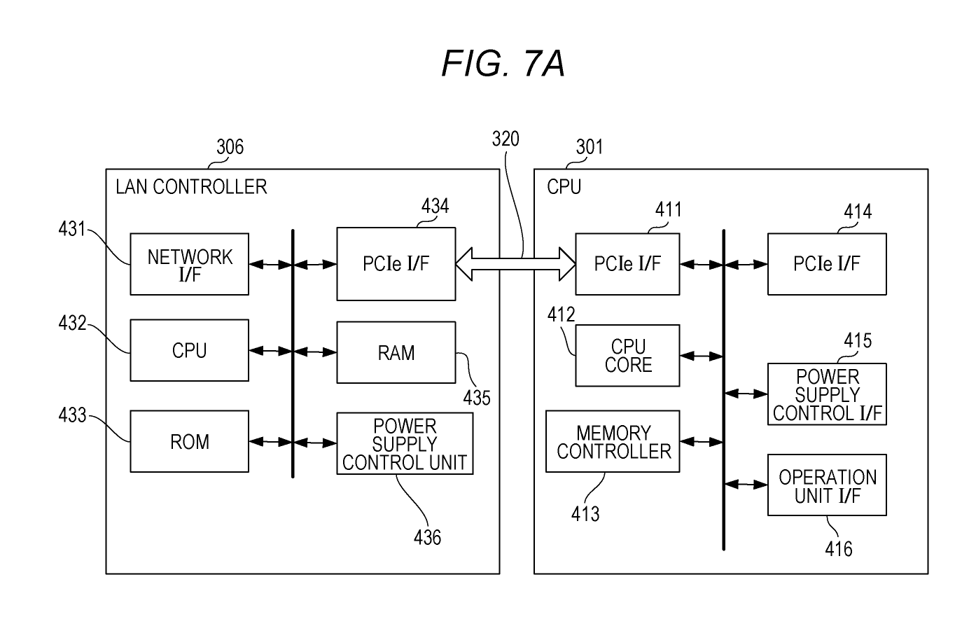

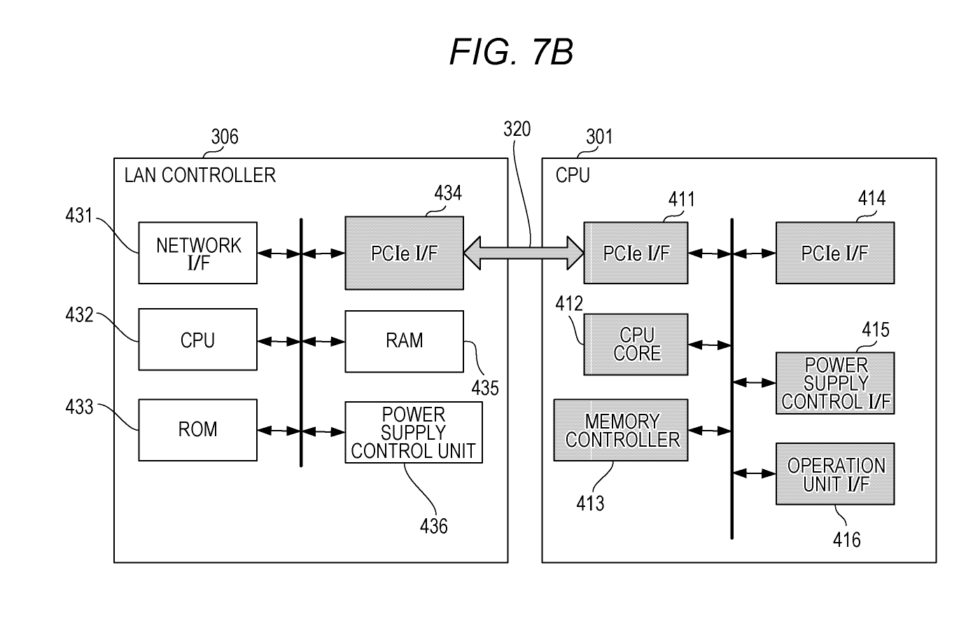

FIG. 7A illustrates a CPU and a LAN controller in active state in wait response mode (S0) and FIG. 7B illustrates a CPU and a LAN controller in low power state in wait response mode (S0).

In active state, as illustrated in FIG. 7A, the CPU 301 is CO state and the LAN controller 306 is D0 state. Specifically, in active state, power is supplied to each unit inside the CPU 301 and each unit inside the LAN controller 306.

In addition, in low power state, as illustrated in FIG. 7B, the CPU 301 is C10 state and the LAN controller 306 is D3 state. Note that, the general-purpose memory 303 connected to the CPU 301 is self-refresh state. In low power state, the PCIe I/F 411, the CPU core 412, the memory controller 413, and the PCIe I/F 414 inside the CPU 301 are power saving state. Power saving state is any of stop of power supply, stop of supply clock, and reduction in frequency of supply clock. In low power state, the PCIe I/F 434 of the LAN controller 306 is power saving state (D3).

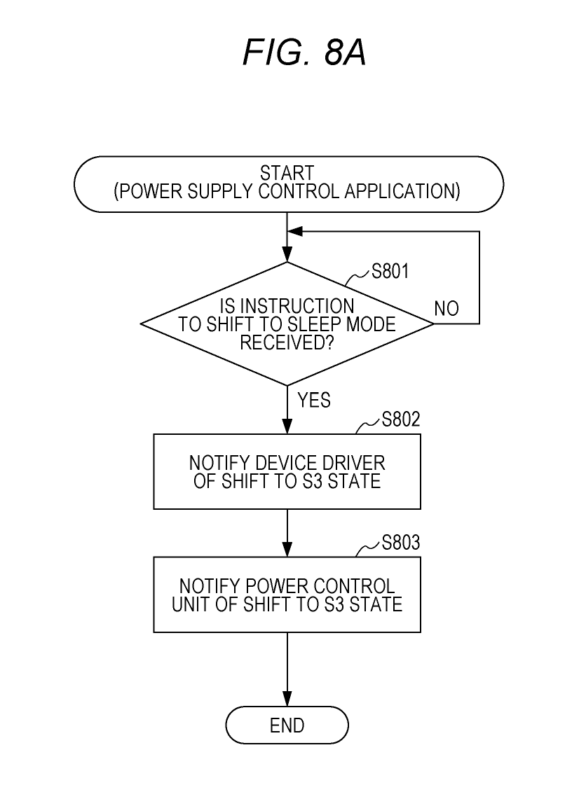

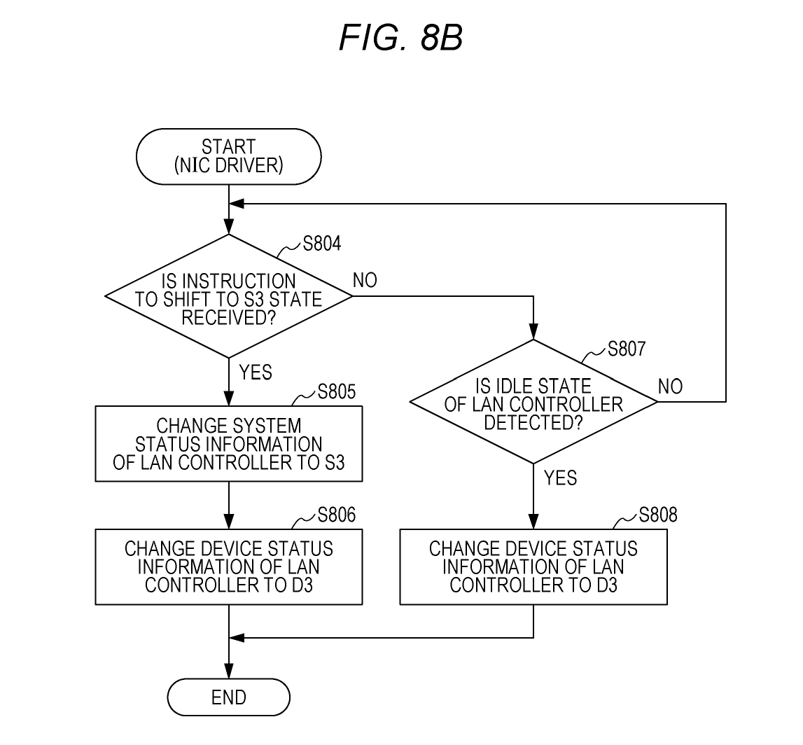

FIG. 8A is a flow chart showing operation of a CPU executing the power supply control application A1.

The CPU 301 determines whether or not an instruction to shift to sleep mode (interrupt signal) is received (S801). When it is determined that an instruction to shift to sleep mode is received (S801: Yes), the CPU 301 notifies the NIC driver that the MFP 101 shifts to S3 state (S802). In addition, the CPU 301 notifies the power supply control unit 201 that the MFP 101 shifts to S3 state (S803).

When the power supply control unit 201 is notified by the CPU 301 that the MFP 101 shifts to S3 state, it stops power supply to the CPU 301, the printer unit, and the scanner unit after execution of sleep shift process by the CPU 301. Accordingly, the MFP 101 shifts to S3 state. Note that, the sleep shift process described above includes process for storing a value of the register of the CPU 301 and process for setting the general-purpose memory 303 that stores a value of the register to self-refresh mode.

FIG. 8B is a flow chart showing operation of a CPU executing the NIC driver.

The CPU 301 determines whether or not shift to S3 state is notified by the power supply control application A1 (S804). When it is determined that shift to S3 state is notified (S804: Yes), the CPU 301 changes the system status information stored in the RAM 435 of the LAN controller 306 to S3 via the PCIe bus 320 (S805). In addition, the CPU 301 changes the device status information stored in the register 437 of the LAN controller 306 to D3 via the PCIe bus 320 (S805).

The NIC driver D2 executed by the CPU 301 can monitor the idle state of the LAN controller 306 and turn the LAN controller 306 into D3 state even if it is not notified of the shift to the S3 state by the power supply control application A1. The CPU 301 determines whether or not the LAN controller 306 is idle state (S807). When it is determined that the LAN controller 306 is idle state, the CPU 301 changes the device status information stored in the register 437 of the LAN controller 306 to D3 via the PCIe bus 320 (S808).

When the device status information of the register 437 is changed to D3, the power supply control unit 436 of the LAN controller 306 refers to the device status information and turns the LAN controller 306 into D3 state (power saving state) illustrated in FIG. 7B.

Next, the process executed by the CPU 432 of the LAN controller 306 will be described.

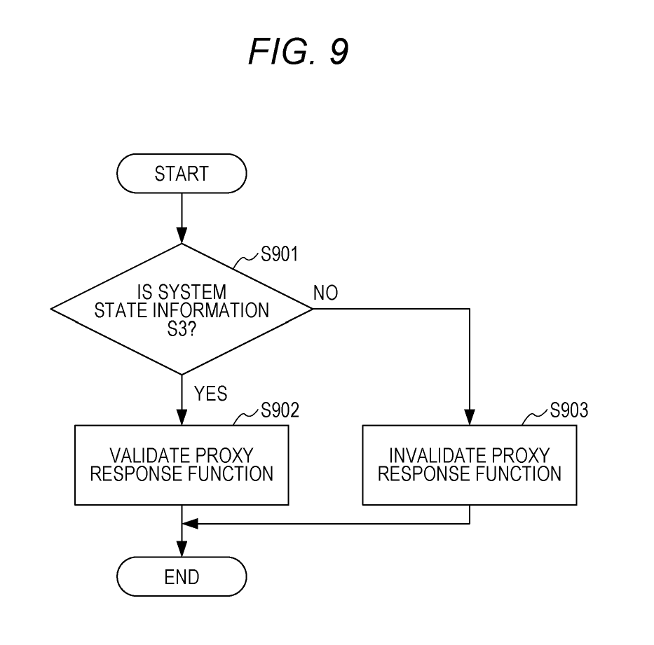

FIG. 9 is a flow chart showing a process executed by the CPU 432 of the LAN controller 306.

First, the CPU 432 determines whether or not the system state information stored in the LAN controller 306 indicates S3 state (S901). When the system state information indicates S3 state (S901: Yes), the CPU 432 validate the proxy response function (S902). When it is determined that the system state information indicates S0 state (S901: No), the proxy response function is invalidated (S903).

Next, operation of the LAN controller 306 in which the proxy response function is validated will be described.

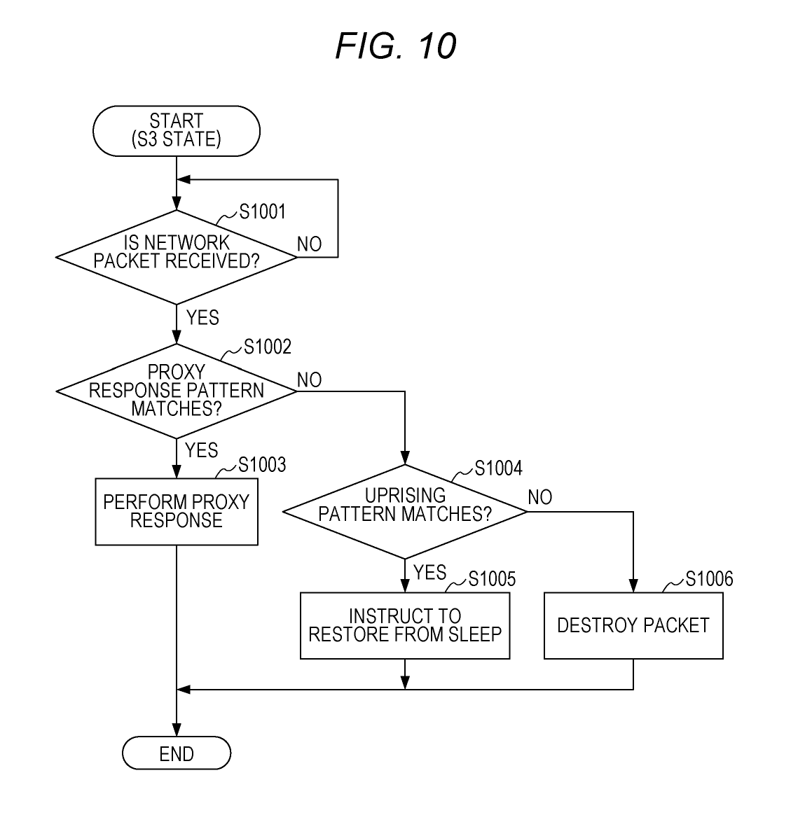

FIG. 10 is a flow chart showing the operation of the LAN controller 306 executing the proxy response function. Each step of FIG. 10 is performed when the MFP 101 is S3 state.

The CPU 432 determines whether or not a network packet is received from the external device 102 (S1001). Then, the CPU 432 determines whether or not the received network packet matches the proxy response pattern (S1002). If the received network packet matches the proxy response pattern (S1002: Yes), the CPU 432 generates a response packet for the received network packet and transmits it to the external device 102 (S1003). If the received network packet does not match the proxy response pattern (S1002: No), it is determined whether or not the received network packet matches the uprising pattern (S1004).

When the received network packet matches the uprising pattern (S1004: Yes), the CPU 432 transmits an instruction to restore to sleep to the power supply control unit 201 (S1005). The power supply control unit 201 that has received the instruction to restore to sleep supplies power to the CPU 432 and the like to which power supply has been stopped. Accordingly, the MFP101 is restored from the S3 state to the S0 state.

Note that, if the received network packet does not match the uprising pattern (S1004: No), the CPU 432 destroys the received network packet (S1006).

Next, an operation of the LAN controller 306 in which the proxy response function is invalidated will be described.

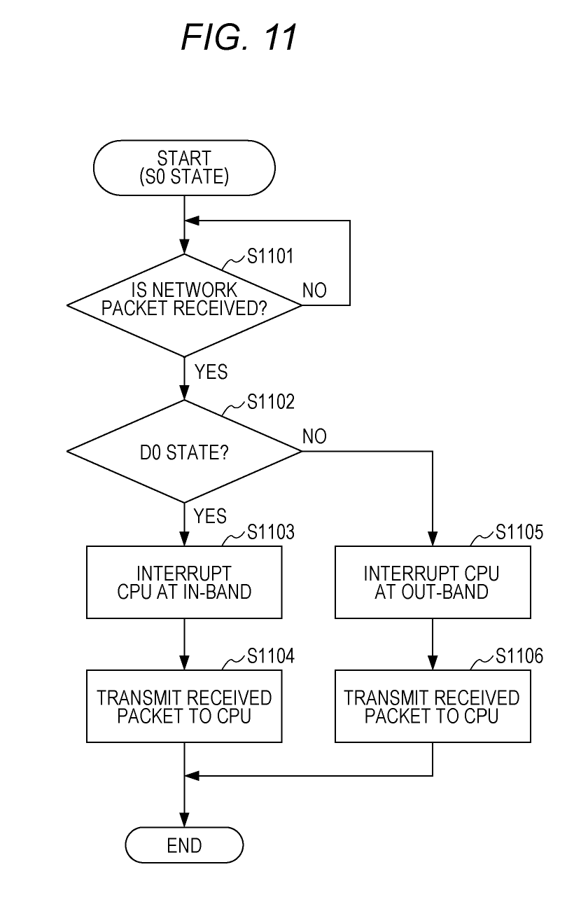

FIG. 11 is a flow chart showing an operation of the LAN controller 306 in which the proxy response function is invalidated. Each step of FIG. 11 is performed when the MFP 101 is S0 state. When the MFP 101 is S0 state, the LAN controller is D0 state or D3 state.

The CPU 432 determines whether or not a network packet is received from the external device 102 (S1101). Then, when it is determined that the network packet is received (S1101: Yes), the CPU 432 refers to the device state information stored in the register 437 and determines whether or not the LAN controller 306 is D0 state (S1102). If the LAN controller 306 is D0 state (S1102: Yes), the CPU 432 issues an interruption to the CPU 301 via the PCIe bus 320 (S1103). The interrupted CPU 301 establishes communication with the LAN controller 306. When communication with the CPU 301 is established, the CPU 432 transmits the received network packet to the CPU 301 (S1104).

On the other hand, if the LAN controller 306 is D3 state (S1102: No), the CPU 432 issues an interruption to the CPU 301 via a signal line different from the PCIe bus 320 (S1105). Specifically, the CPU 432 issues an interruption to the CPU 301 via the power supply control unit 201. The interrupted CPU 301 establishes communication with the LAN controller 306. When communication with the CPU 301 is established, the CPU 432 transmits the received network packet to the CPU 301 (S1106).

### <Effect of First Embodiment>

While the LAN controller 306 has determined whether or not to perform proxy response on the basis of device state information, it determines whether or not to perform proxy response on the basis of system state information in the first embodiment. Accordingly, it is possible to prevent the LAN controller 306 from performing proxy response when the system state is S0 state and the device state is D3 state. Therefore, it is possible to respond to a packet received by the CPU 301 in the S0 state in which power supply to the CPU 301 is not stopped.

### Second Embodiment

While an example in which the CPU 301 informs system state information via the PCIe bus 320 has been described in the first embodiment, a method for informing system state information is not limited to the method of the first embodiment. In the second embodiment, system state information is informed by a side band (communication path) different from the PCIe bus 320.

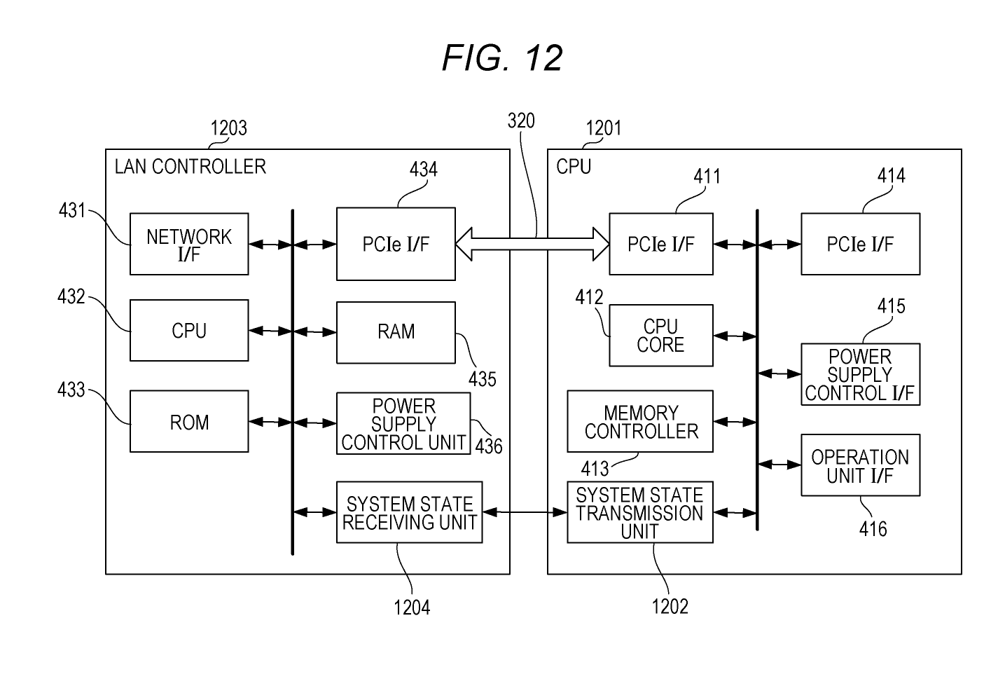

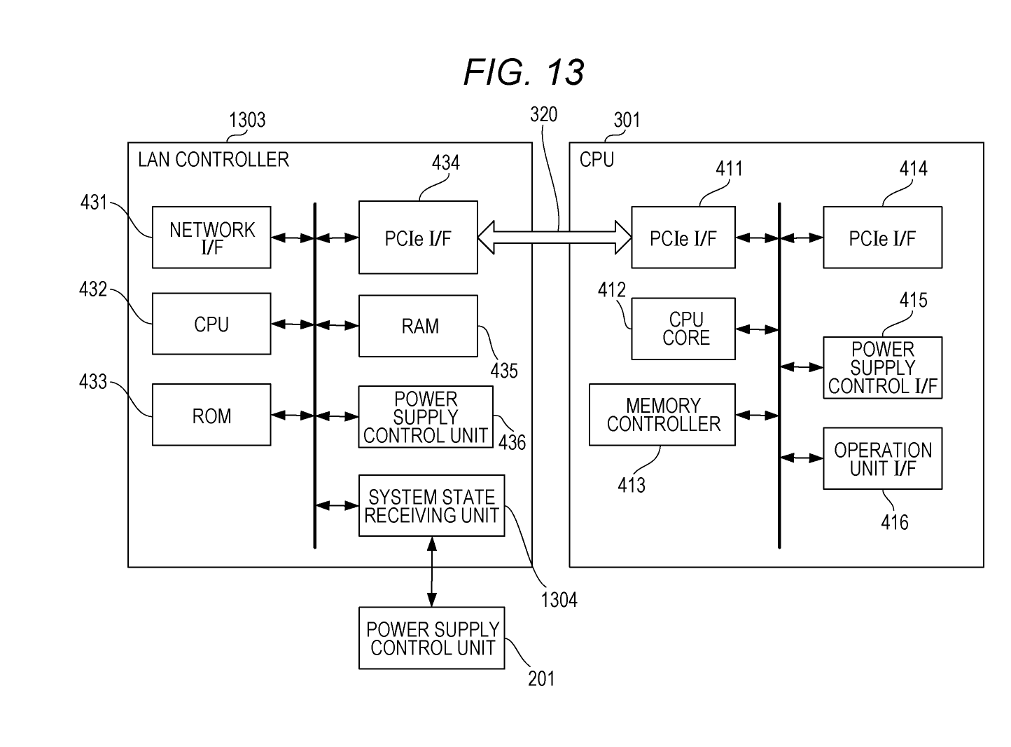

As illustrated in FIG. 12, a CPU 1201 in the second embodiment includes a system state transmission unit 1202 in addition to the PCIe I/F 411, the CPU core 412, the memory controller 413, the PCIe I/F 414, the power supply control I/F 415, and the operation unit I/F 416. In addition, a LAN controller 1203 in the second embodiment includes a system state receiving unit 1204 in addition to the phy 431, the CPU 432, the ROM 433, the PCIe I/F 434, the RAM 435, and the power supply control unit 436.

Then, in the second embodiment, the system state transmission unit 1202 controls an output port (for example, turn into high level) and notifies the LAN controller 1203 of system status. The system status information stored in the RAM 435 of the LAN controller 1203 becomes S3 state or S0 state by controlling the output port.

### Third Embodiment

In the second embodiment, an example in which the system state transmission unit 1202 of the CPU 301 notifies system state information by a side band different from the PCIe bus 320 has been described. However, a method for informing system state information is not limited to the methods of the first embodiment and the second embodiment. In the third embodiment, the power supply control unit 201 notifies the LAN controller 1303 of system state information by a side band (communication path) different from the PCIe bus 320.

As illustrated in FIG. 12, the LAN controller 1203 of the third embodiment includes a system state receiving unit 1304 in addition to the phy 431, the CPU 432, the ROM 433, the PCIe I/F 434, the RAM 435, and the power supply control unit 436.

Then, in the third embodiment, the power supply control unit 201 controls an output port (for example, turn into high level) and notifies a LAN controller 1303 of system status information. The system status information stored in the RAM 435 of the LAN controller 1203 becomes S3 state or S0 state by controlling the output port of the power supply control unit 201.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-091613, filed Apr. 28, 2016, which is hereby incorporated by reference herein in its entirety.

What is claimed is:

1. An information processing device that can communicate with an external device, comprising:
a controller for controlling the information processing device; and
a network interface that communicates data with the external device via a network, the network interface performing proxy response for transmitting a response to specific data received from the external device via the network to the external device without the controller,
wherein the network interface comprises a storage unit for storing system status information that indicates a power state of the information processing device and determines whether or not to perform the proxy response on the basis of the system status information stored in the storage unit.

2. The information processing device according to claim 1, wherein the network interface does not perform the proxy response in a case that the system status information stored in the storage unit shows a standby state and performs the proxy response in a case that the system status information stored in the storage unit shows a sleep state that consumes less power than the standby state.

3. The information processing device according to claim 2, wherein the network interface does not perform the proxy response and transmits the received specific data to the controller in a case that the system status information stored in the storage unit shows the standby state.

4. The information processing device according to claim 2, wherein power is supplied to the controller in the standby state and power supply to the controller is stopped in the sleep state.

5. The information processing device according to claim 1, wherein the network interface further comprises a register for storing device status information indicating a power state of the network interface and a power control unit for controlling the power state of the network interface on the basis of the device status information stored in the register.

6. The information processing device according to claim 5, wherein the controller writes device status information of the register via a bus that connects the controller and the network interface so as to communicate with each other.

7. The information processing device according to claim 6, wherein the controller notifies the network interface of the system status information via the bus.

8. The information processing device according to claim 6, wherein the controller notifies the network interface of the system status information via a communication path different from the bus.

9. The information processing device according to claim 8, further comprising a power control unit for holding the system status information and controlling power supply to each unit of the information processing device on the basis of the system status information,
wherein the power control unit notifies the network interface of the system status information via the communication path.

10. The information processing device according to claim 6, wherein, when data is received from the external device via a network, the network interface issues an interruption to the controller via the bus in a case that the register shows a normal power state, and the network interface issues an interruption to the controller via a communication path different from the bus in a case that the register shows a power saving state.

11. The information processing device according to claim 6, wherein the bus is a bus that is compliant with PCI Express standard.

12. The information processing device according to claim 1, further comprising a printing unit for printing an image on a sheet.
